(19) United States
(12) Patent Application Publication
(10) Pub. No.: US 2007/0156441 A1
(43) Pub. Date: Jul. 5, 2007

(54) System and method for generating and administering a refundable ticket for an entertainment facility

(76) Inventor: Stephen Leal Tupper, Bloomfield Hills, MI (US)

Correspondence Address: Stephen Leal Tupper, 620 Wilshire, Bloomfield Hills, MI, 48302, US

(21) Appl. No.: 11/604,550

(22) Filed: Nov. 27, 2006

Related U.S. Application Data
(60) Provisional application No. 60/740,982, filed on Nov. 30, 2005.

(51) Int. Cl. G06Q 99/00

(52) U.S. Cl. 705/1; 705/5

(57) ABSTRACT

A system and a method for providing a ticket for entering an entertainment facility and administering provisions of the ticket are provided. The method includes generating the ticket that permits a person to enter the entertainment facility. The ticket is offered for a price. The ticket has one or more legal provisions permitting at least a partial refund of the price if a first atmospheric condition doe not occur at a first predetermined time proximate to the entertainment facility or the first atmospheric condition is not forecasted to occur at the first predetermined time proximate to the entertainment facility. The method further includes selling the ticket to the person for the price. The method further includes refunding at least a portion of the price when the first atmospheric condition does not occur at the first predetermined time proximate to the entertainment facility or the first atmospheric condition is not forecasted to occur at the first predetermined time proximate to the entertainment facility.

### CROSS-REFERENCE TO RELATED APPLICATIONS

This application claims the benefit of U.S. Provisional Patent Application No. 60/740,982 filed on Nov. 30, 2005, which is incorporated by reference herein in its entirety.

### TECHNICAL FIELD

This application relates to a system and a method for generating and administering a refundable ticket for an entertainment facility.

### BACKGROUND

Current ticket generation systems allow a user to purchase a ticket that allows entry into the entertainment facility. In particular, the ticket has legal provisions allowing entry into the entertainment facility for a predetermined price on a predetermined date. The ticket, however, does not contain legal provisions that allow the purchaser to obtain a refund when predetermined atmospheric conditions are not met.

A problem with the foregoing ticket generation system is that when weather or atmospheric conditions proximate the entertainment facility causes the purchaser to not utilize the ticket, the purchaser is not able to automatically get a refund of at least a portion of the ticket price. For example, when rainfall or undesirable air temperatures induce the purchaser to not utilize the ticket for entry into an entertainment facility, such as an amusement park, the purchaser is not able to automatically get a refund for the ticket.

Accordingly, the inventor herein has recognized that there is a need for a system and a method for generating refundable tickets for an entertainment facility that allows a purchaser to obtain a refund of the purchase price when predetermined atmospheric conditions proximate the entertainment facility are not met.

### SUMMARY

A method for providing a ticket for entering an entertainment facility and administering provisions of the ticket in accordance with an exemplary embodiment is provided. The method includes generating the ticket that permits a person to enter the entertainment facility. The ticket is offered for a price. The ticket has one or more legal provisions permitting at least a partial refund of the price if a first atmospheric condition doe not occur at a first predetermined time proximate to the entertainment facility or the first atmospheric condition is not forecasted to occur at the first predetermined time proximate to the entertainment facility. The method further includes selling the ticket to the person for the price. The method further includes refunding at least a portion of the price when the first atmospheric condition does not occur at the first predetermined time proximate to the entertainment facility or the first atmospheric condition is not forecasted to occur at the first predetermined time proximate to the entertainment facility.

A system for providing a ticket for entering an entertainment facility and administering provisions of the ticket in accordance with another exemplary embodiment is provided. The system includes an atmospheric monitoring station configured to generate a first atmospheric parameter value indicative of an atmospheric condition proximate the entertainment facility. The system further includes a computer operably communicating with the atmospheric monitoring station. The computer is configured to generate the ticket that permits a person to enter the entertainment facility. The ticket is offered for a price. The ticket has one or more legal provisions permitting at least a partial refund of the price if the first atmospheric condition does not occur at a first predetermined time proximate to the entertainment facility. The computer is further configured to query the first atmospheric monitoring station to obtain the first atmospheric parameter value. The computer is further configured to indicate that a portion of the price is be refunded when the first atmospheric parameter value indicates that the first atmospheric condition did not occur at the first predetermined time proximate to the entertainment facility.

A system for providing a ticket for entering an entertainment facility and administering provisions of the ticket in accordance with another exemplary embodiment is provided. The system includes an atmospheric forecasting system configured to generate a forecasted atmospheric parameter value at a first predetermined time indicative of a first atmospheric condition at a second predetermined time proximate the entertainment facility. The first predetermined time precedes the second predetermined time. The system further includes a computer operably communicating with the atmospheric forecasting station. The computer is configured to generate the ticket that permits a person to enter the entertainment facility. The ticket is offered for a price. The ticket has one or more legal provisions permitting at least a partial refund of the price if the forecasted atmospheric parameter value indicates that the first atmospheric condition will not occur at the second predetermined time proximate to the entertainment facility. The computer is further configured to query the first atmospheric monitoring station to obtain the forecasted atmospheric parameter value. The computer is further configured to indicate that a portion of the price is be refunded when the forecasted atmospheric parameter value indicates that the first atmospheric condition will not occur at the second predetermined time proximate to the entertainment facility.

### BRIEF DESCRIPTION OF THE DRAWINGS

FIG. 1 is a block diagram of a system for generating and administering a refundable ticket for entering an entertainment facility;

FIG. 2 is a schematic of a front side of a non-refundable ticket generated by the system of FIG. 1;

FIG. 3 is a schematic of a front side of a refundable ticket generated by the system of FIG. 1;

FIG. 4 is a schematic of a front side of another refundable ticket generated by the system of FIG. 1;

FIG. 5 is a schematic of a backside of the non-refundable ticket of FIG. 2;

FIG. 6 is a schematic of a ticket transaction database utilized in the system of FIG. 1;

FIG. 7 is a schematic of a data request message generated by the system of FIG. 1;

FIG. 8 is a schematic of a data return message generated by the system of FIG. 1;

FIG. 9 is a schematic of another data request message generated by the system of FIG. 1;

FIG. 10 is a schematic of another data return message generated by the system of FIG. 1; and

FIGS. 11-16 are flowcharts of a method for providing a ticket for entering an entertainment facility and administering provisions of the ticket.

### DESCRIPTION OF EXEMPLARY EMBODIMENTS

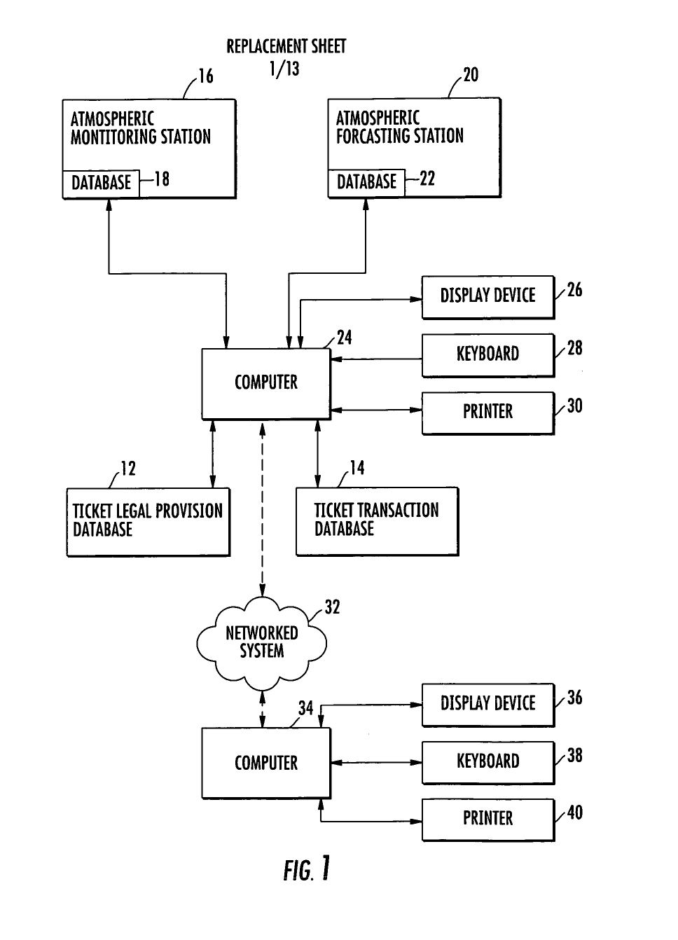

Referring to FIG. 1, a system 10 for generating tickets allowing entry into an entertainment facility is illustrated. The term “ticket” is a legal instrument that grants a bearer or purchaser a right to enter an entertainment facility for a predetermined event. A ticket can have various forms including a document form, an electronic record, or the like. The term “entertainment facility” means any indoor or outdoor location that can be utilized as a venue for an entertainment event. For example, an entertainment facility can comprise an indoor concert hall, an outdoor concert area, an auditorium, a sports arena, a sports field, and a roped-off area for preventing entry into predetermined area. Of course, other types of venues for holding events that are known to those skilled in the art fall within the definition of an entertainment facility. The system 10 includes a ticket legal provision database 12, a ticket transaction database 14, an atmospheric monitoring station 16, an atmospheric forecasting system 20, a computer 24, a display device 26, a keyboard 28, and a printer 30. The system 10 can further optionally include a networked system 32, a computer 34, a display device 36, a keyboard 38, and a printer 40.

Referring to FIG. 1, the ticket legal provision database 12 is provided to store legal provisions that will be utilized to generate either a nonrefundable ticket or a refundable ticket. The ticket legal provision database 12 is operably coupled to the computer 24 for communication therewith.

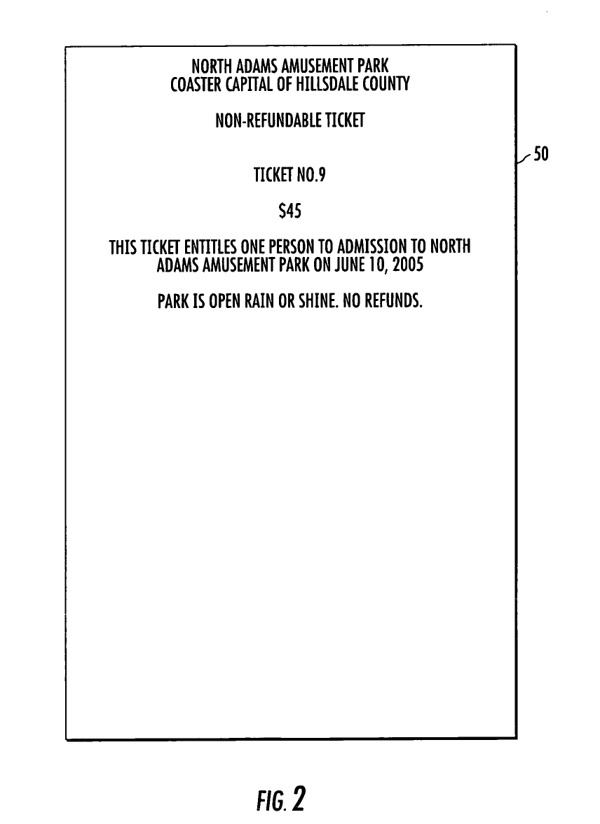

A nonrefundable ticket is a ticket in which a purchaser buys a ticket for predetermined price and does not provide any legal provisions for refunding any portion of a price for the ticket. For example, referring to FIG. 2, a nonrefundable ticket 50 is illustrated. The ticket legal provision database 12 stores the information shown on the ticket 50 therein.

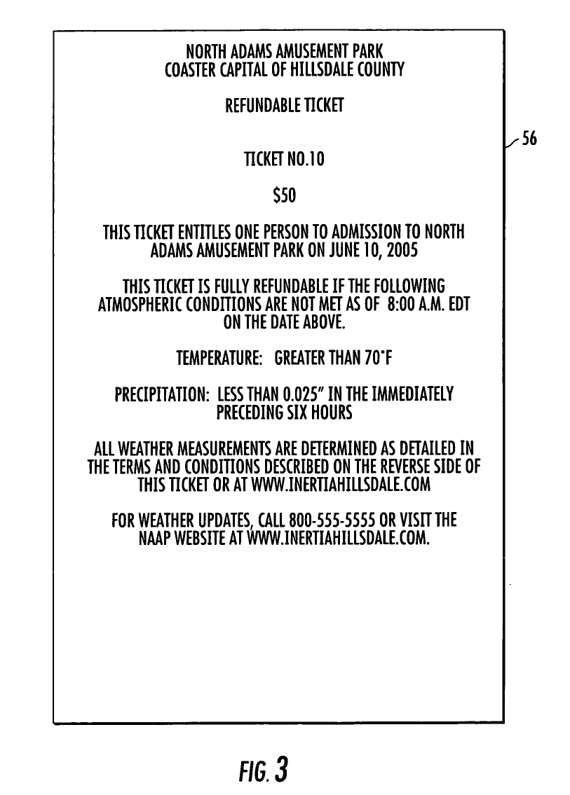

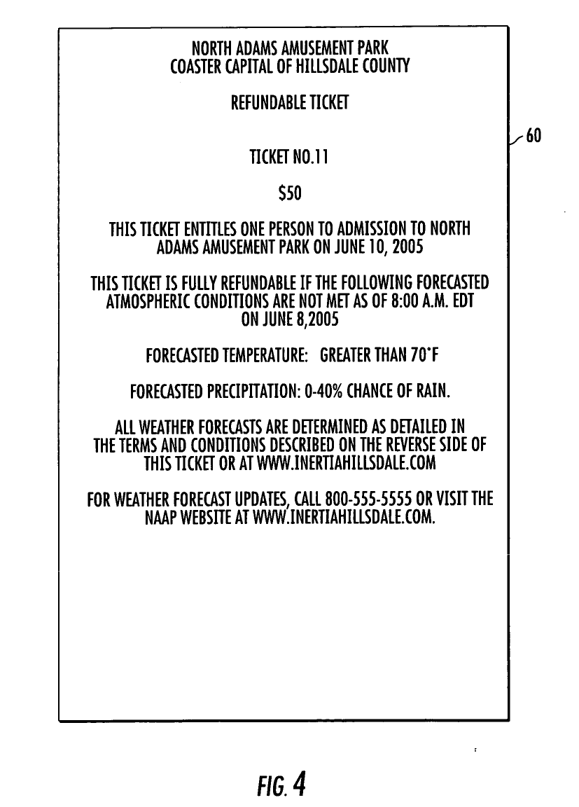

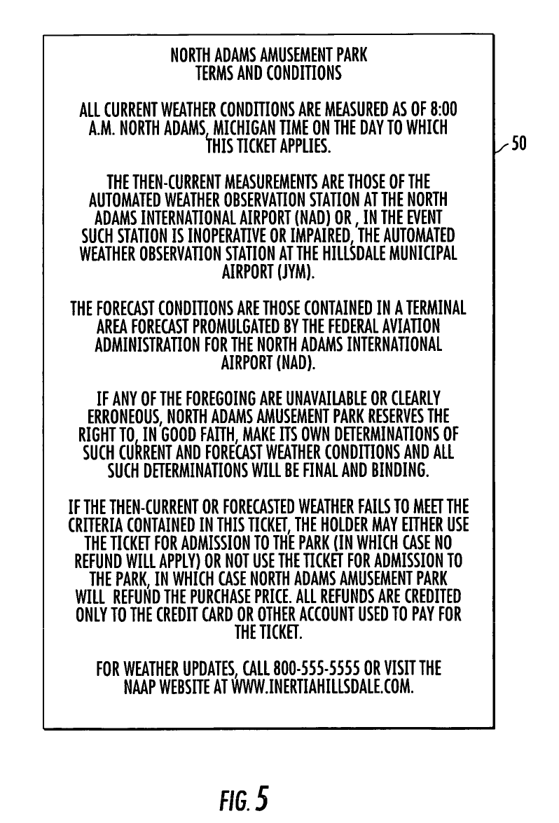

A refundable ticket is a ticket in which the purchaser buys a ticket for a predetermined price and the ticket does have legal provisions allowing for a partial or full refund of the predetermined price of the ticket. For example, referring to FIG. 3, a refundable ticket 56 is illustrated whose legal provisions allow a purchaser to obtain a refund of the purchase price based upon measured atmospheric conditions. In particular, refundable ticket 56 allows a purchaser to obtain the refund of the purchase price when the following atmospheric conditions are not met at a predetermined time: temperature greater than 70 degrees Fahrenheit, and precipitation less than 0.025 inches. The ticket legal provision database 12 stores the information shown on the ticket 56 therein. Further, for example, referring to FIG. 4, the refundable ticket 60 is illustrated whose legal provisions allow a purchaser to obtain a refund of the purchase price based upon forecasted weather or atmospheric conditions. In particular, the refundable ticket 60 allows a purchaser to obtain the refund of the purchase price when the following forecasted atmospheric conditions are not met at a predetermined time: forecasted temperature greater than 70 degrees Fahrenheit, and forecasted precipitation 0-40%. It should be noted that the ticket legal provision database 12 can store a plurality of other legal provisions including various conditions for a full or partial refund of a purchase price of a ticket. Thus the legal provisions indicated on tickets 50, 56 are for purposes of illustration only and are non-limiting.

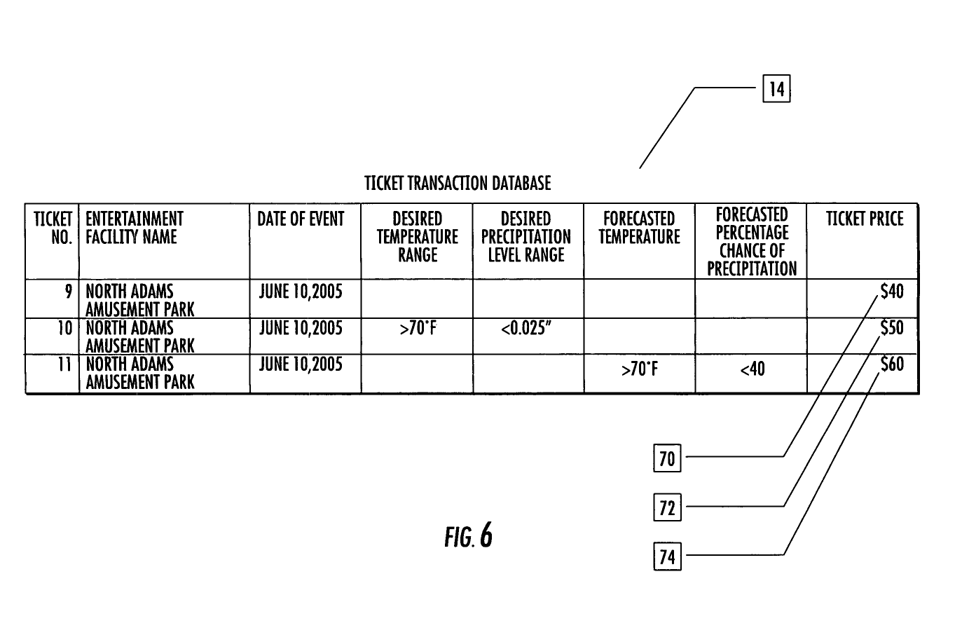

Referring to FIGS. 1 and 6, the ticket transaction database 14 is provided to store information associated with purchased tickets. The ticket transaction database 14 is operably coupled to the computer 24 for communication therewith. The ticket transaction database 14 includes the following fields of information: (i) a ticket number, (ii) an entertainment facility name, (iii) a date of an event, (iv) a desired temperature range, (v) a desired precipitation level range, (vi) a forecasted temperature, (vii) a forecasted percentage chance of precipitation range, and (viii) a ticket price. Further, the ticket transaction database 14 is updated with a new record by the computer 24 each time a new ticket is generated by the system 10 for a purchaser of the ticket. For example, when the computer 24 generates the ticket 50 for a purchaser, the computer 24 stores in the record 70 containing information associated with the ticket 50 in the ticket transaction database 14. Further, for example, when the computer 24 generates the ticket 56 for a purchaser, the computer 24 stores a record 72 containing information associated with the ticket 56 in the ticket transaction database 14. Further, for example, when the computer 24 generates the ticket 60 for the purchaser, the computer 24 stores a record 74 containing information associated with the ticket 60 in the ticket transaction database 14.

Referring to FIG. 1, the atmospheric monitoring station 16 is provided to generate atmospheric parameter values indicative of atmospheric conditions in a region proximate an entertainment facility. In one exemplary embodiment, the atmospheric monitoring station 16 comprises a stand-alone atmospheric monitoring station such as the Ultmeter 2100 manufactured by Peet Bros company located in St. Cloud, Fla. In another exemplary embodiment, the station 16 can comprise one or more automated weather observation stations (AWOS) and automated surface observation stations (ASOS) operated by government agencies. The atmospheric parameter values that can be generated by the atmospheric monitoring station 16 include at least one of: (i) a temperature level, (ii) a precipitation level, (iii) a percentage chance of precipitation, (iv) a type of precipitation, (v) an amount of lightning, (vi) a proximity of lightning, (vii) a density of lightning, (viii) a percentage of cloud cover, (ix) a barometric pressure level, (x) a wind direction, (xi) a wind speed, (xii) a wind gust speed, (xiii) a visibility distance, (xiv) a cloud altitude, and (xv) a dew point temperature.

The atmospheric forecasting system 20 is provided to obtain or retrieve forecasted atmospheric parameter values indicative of forecasted atmospheric conditions in a region proximate an entertainment facility. The atmospheric forecasting system 20 is configured to operably communicate with the computer 24. The atmospheric parameter values that can be forecasted by the atmospheric forecasting station 20 include at least one of: (i) a temperature level, (ii) a precipitation level, (iii) a percentage chance of precipitation, (iii) a type of precipitation, (iv) a percentage of cloud cover, (v) a barometric pressure level, (vi) a wind direction, (vii) a wind speed, (viii) a wind gust speed, (ix) a visibility distance, (x) a cloud altitude, and (xi) a dew point temperature.

The computer 24 is provided to generate a ticket for a purchaser of the ticket and to assist in the administration of the ticket during a partial or full refund of the ticket price of the ticket. The computer 24 operably communicates with the ticket legal provision database 12, and the ticket transaction database 14 for obtaining the information utilized to generate a ticket and for storing transaction data associated with the ticket. The computer 24 further operably communicates with the atmospheric monitoring station 16 and the atmospheric forecasting system 20 for obtaining the atmospheric parameter values utilized to determine whether the purchaser of the ticket is entitled to a partial or full refund of the ticket price. The computer 24 is further operably coupled to the display device 26, the keyboard 28, and the printer 30. The display device 26 is provided to display information associated with a purchased ticket. The keyboard 28 is provided to allow an operator to input information associated with either a generation of the ticket or a refund request associated with the ticket. The printer 30 is provided to allow an operator to print out a hard copy of the ticket.

The networked system 32 is provided to allow the computer 34 at a remote site to communicate with the computer 24. The computer 34 operably communicates with the computer 24 to allow an operator to generate a ticket at a remote site and to administer provisions associated with the ticket at the remote site. Further, the computer 24 allows an operator to administer provisions of the ticket such as a partial or full refund of the ticket price. The remote computer 34 is operably coupled to the display device 36, the keyboard 38, and the printer 40. The display device 36 is provided to display information associated with a purchased ticket. The keyboard 38 is provided to allow an operator to input information associated with either a generation of the ticket or a refund request associated with the ticket. The printer 40 is provided to allow an operator to print out a hard copy of a ticket.

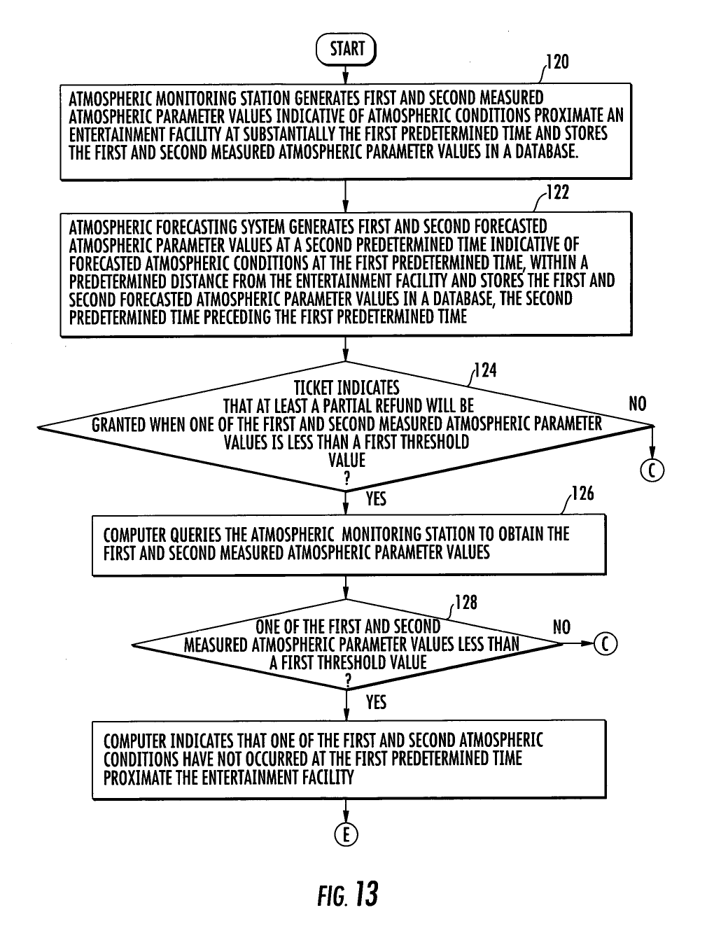

Referring to FIGS. 11-12, a method for providing the ticket for entering an entertainment facility and administering provisions of the ticket is illustrated. In particular, the method will be utilized to either generate a non-refundable ticket, or a refundable ticket being refundable based on one or more atmospheric parameter values or one or more forecasted atmospheric parameter values. The method can be implemented utilizing the system 10 described above.

At step 98, an operator inputs ticket information utilizing the keyboard 28.

Next at step 100, the computer 24 makes a determination as to whether the operator has requested a refundable ticket for a person purchasing the ticket, based on inputted information. If the value of step 100 equals “yes”, the method advances to step 102. Otherwise, the method advances to step 106.

At step 102, the computer 24 generates a first ticket that permits the person to enter an entertainment facility. The first ticket is offered for a first price. The first ticket has one or more legal provisions permitting at least a partial refund of the first price if first and second atmospheric conditions do not occur at the first predetermined time proximate to the entertainment facility, or first and second atmospheric conditions are not forecasted to occur at a first predetermined time proximate to the entertainment facility. In particular, the computer 24 generates the first ticket by accessing the legal provision database 12 to obtain information to be printed on the first ticket, and thereafter utilizes the printer 30 to print the first ticket. Further, the computer 24 stores a record in the ticket transaction database 14 relating to the first ticket.

Next at step 104, the operator sells the first ticket to the person for the first price. After step 104, the method is exited.

Referring again to step 100, when the value of step 100 equals “no”, the method advances to step 106. At step 106, the computer 24 makes a determination as to whether the operator has requested a non-refundable ticket for a person, based on the inputted information. If the value of step 106 equals “yes”, the method advances to step 108. Otherwise, the method advances to step 110.

At step 108, the computer 24 generates a second ticket that permits the person to enter the entertainment facility where the second ticket is offered for a second price less than the first price of the first ticket. After step 108, the method is exited.

At step 110, the computer 24 makes a determination as to whether the operator has requested a least a partial refund of the first price of the first ticket, based on information inputted by the operator. If the value of step 110 equals “yes”, the method advances to step 112. Otherwise, the method is exited.

At step 112, the operator refunds at least a portion of the first price of the first ticket when the computer 24 indicates that the first and second atmospheric conditions have not occurred at the first predetermined time proximate to the entertainment facility, or the first and second atmospheric conditions are not forecasted to occur at the first predetermined time proximate to the entertainment facility.

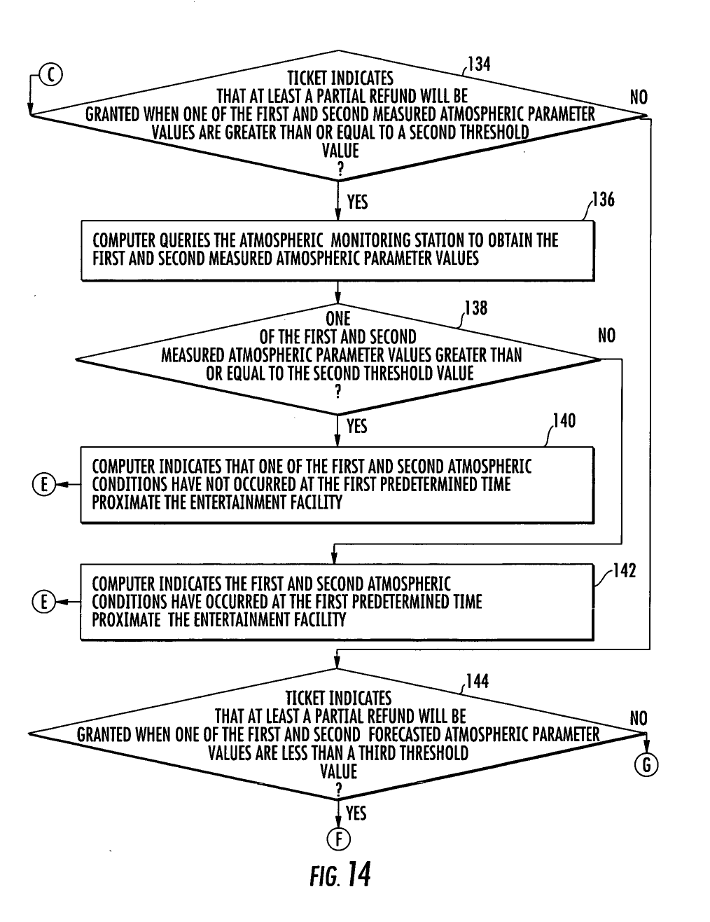

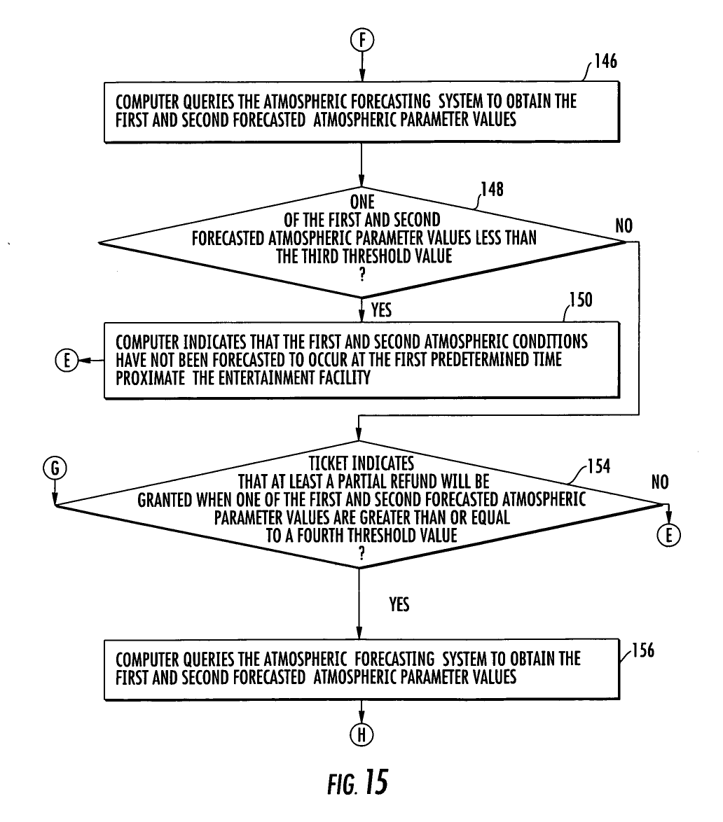

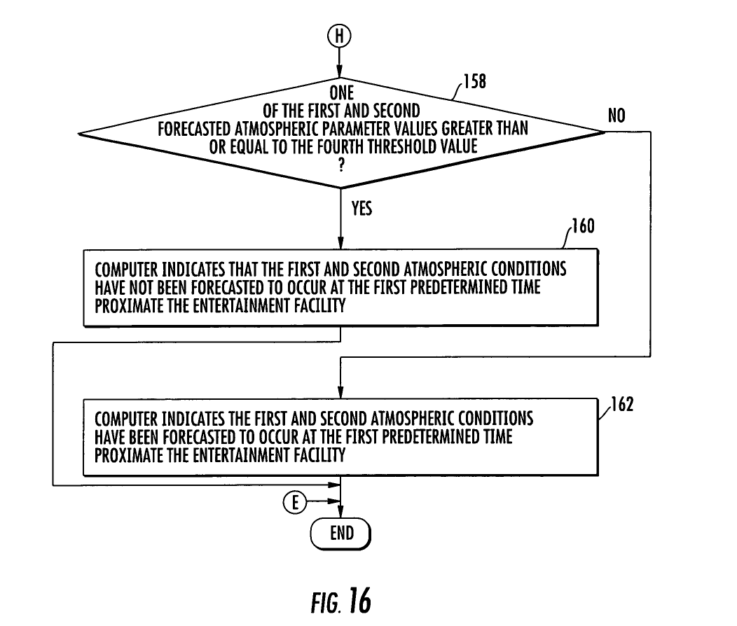

Referring to FIG. 13-16, the step 112 is implemented utilizing the steps 120-162.

At step 120, the atmospheric monitoring station 16 generates first and second measured atmospheric parameter values indicative of atmospheric conditions proximate an entertainment facility at substantially the first predetermined time and stores the first and second measured atmospheric parameter values in a database 18. For example, the atmospheric monitoring station 16 can generate a measured temperature value of 70 degrees Fahrenheit and precipitation value of zero inches and store the temperature value and a precipitation value in the database 18.

At step 122, the atmospheric forecasting system 20 generates first and second forecasted atmospheric parameter values at a second predetermined time indicative of forecasted atmospheric conditions at the first predetermined time, within a predetermined distance from the entertainment facility, and stores the first and second forecasted atmospheric parameter values in a database 22. For example, the atmospheric forecasting system 20 can generate a forecasted temperature value of 65 degrees and a forecasted percentage chance of precipitation value of 10 percent and can store the temperature value and forecasted percentage chance of precipitation value in the database 22. The second predetermined time precedes the first predetermined time.

Next at step 124, the computer 24 makes a determination as to whether the ticket indicates that at least a partial refund will be granted when at least one of the first and second measured atmospheric parameter values are less than a first threshold value, based on information input by an operator. If the value of step 124 equals “yes”, the method advances to step 126. Otherwise, the method advances to step 134.

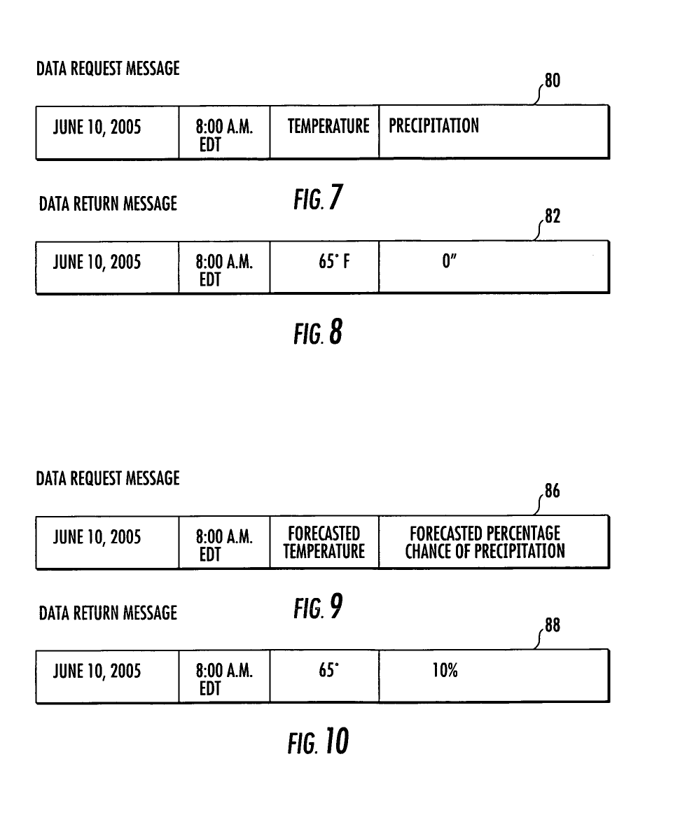

At step 126, the computer 24 queries the atmospheric monitoring station 16 to obtain the first and second measured atmospheric parameter values. For example, referring to FIGS. 7 and 8, the computer 24 can transmit a data request message 80 to the atmospheric monitoring station 16 to obtain the temperature level and a precipitation level proximate the entertainment facility. In response to the data request message 80, the atmospheric monitoring system 16 can return a data return message 82 to the computer 24 having the measured temperature level of 65 degrees Fahrenheit and a precipitation level of zero inches.

Next at step 128, the computer 24 makes a determination as to whether at least one of the first and second measured atmospheric parameter values are less than a first threshold value. For example, the computer 24 can compare the measured temperature level of 65 degrees Fahrenheit in the data return message 82 to the threshold value of 70 degrees Fahrenheit in the record 72, to determine that the measured temperature level is less than the threshold value. If the value of step 128 equals “yes”, the method advances to step 130. Otherwise, the method advances to step 132.

At step 130, the computer 24 indicates that the first and second atmospheric conditions have not occurred at the first predetermined time proximate the entertainment facility. After step 130, the method is exited.

At step 132, the computer 24 indicates the first atmospheric condition has occurred at the first predetermined time proximate the entertainment facility. After step 132, the method is exited.

Referring again to step 124, when the value of step 124 equals “no”, the method advances to step 134. At step 134, the computer 24 makes a determination as to whether the ticket indicates that at least a partial refund will be granted when at least one of first and second measured atmospheric parameter values are greater than or equal to a second threshold value, based on information inputted by the operator. If the value of step 134 equals “yes”, the method advances to step 136. Otherwise, the method advances to step 144.

At step 136, the computer 24 queries the atmospheric monitoring station 16 to obtain the first and second measured atmospheric parameter values.

Next at step 138, the computer 24 makes a determination as to whether at least one of the first and second measured atmospheric parameter values are greater than or equal to the second threshold value. If the value of step 138 equals “yes”, the method advances to step 140. Otherwise, the method advances to step 142.

At step 140, the computer 24 indicates that the first and second atmospheric conditions have not occurred at the first predetermined time proximate the entertainment facility. After step 140, the method is exited.

At step 142, the computer 24 indicates the first atmospheric condition has occurred at the first predetermined time proximate the entertainment facility. After step 142, the method is exited.

Referring again to step 134, when the value of the step 134 equals “no”, the method advances to step 144. At step 144, the computer 24 makes a determination as to whether the ticket indicates that at least a partial refund will be granted when at least one of the first and second forecasted atmospheric parameter values are less than a third threshold value. If the value of step 144 equals “yes”, the method advances to step 146. Otherwise, the method advances to step 154.

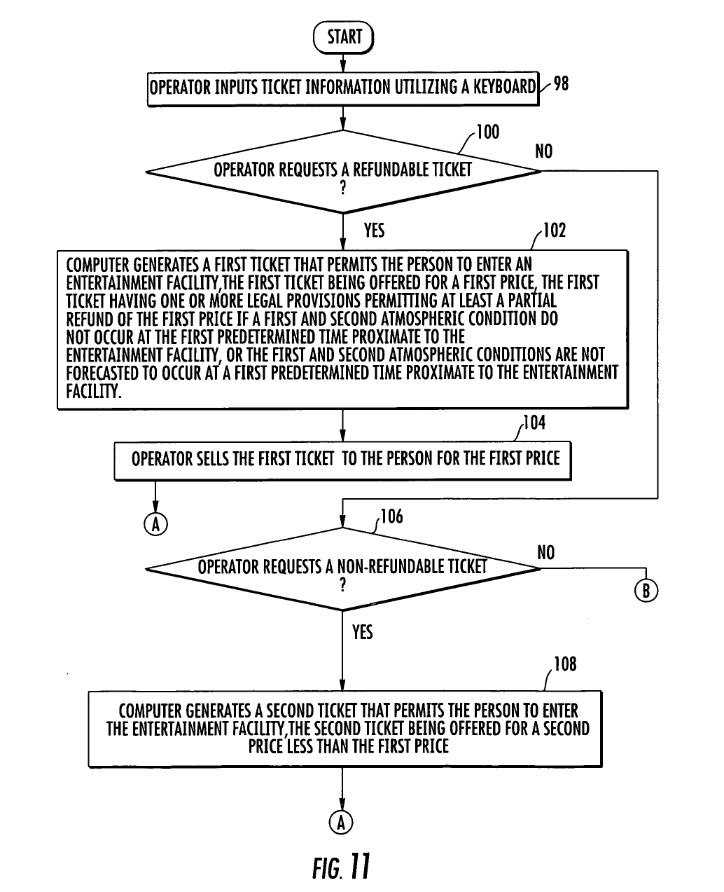

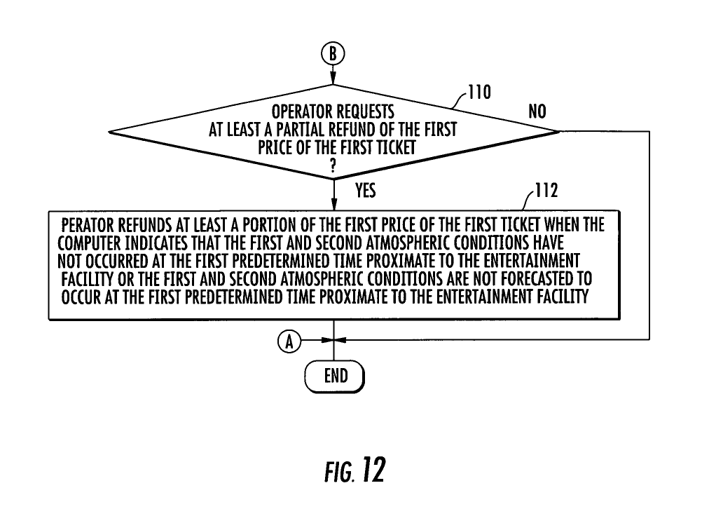

At step 146, the computer 24 queries the atmospheric forecasting system 16 to obtain the first and second forecasted atmospheric parameter values. For example, referring to FIGS. 9 and 10, the computer 24 can transmit a data request message 86 to the atmospheric forecasting station 20 to obtain the forecasted temperature level and a forecasted percentage chance of precipitation proximate the entertainment facility. In response to the data request message 86, the atmospheric forecasting system 16 can return a data return message 88 to the computer 24 having the forecasted temperature level of 65 degrees Fahrenheit and a forecasted percentage chance of precipitation of 10 percent.

Next at step 148, the computer 24 makes a determination as to whether at least one of the first and second forecasted atmospheric parameter values are less than the third threshold value. For example, the computer 24 can compare the forecasted temperature level of 65 degrees Fahrenheit in the data return message 88 to the threshold value of 70 degrees Fahrenheit in the record 74 to determine that the forecasted temperature level is less than the threshold value. If the value of step 148 equals “yes”, the method advances to step 150. Otherwise, the method advances to step 152.

At step 150, the computer 24 indicates that the first and second atmospheric conditions have not been forecasted to occur at the first predetermined time proximate the entertainment facility. After step 150, the method is exited.

At step 152, the computer 24 indicates at least one of the first and second atmospheric conditions have been forecasted to occur at the first predetermined time proximate the entertainment facility. After step one or 52, the method is exited.

Referring again to step 144, when the value of step 144 equals “no”, the method advances to step 154. At step 154, the computer 24 makes a determination as to whether the ticket indicates that at least a partial refund will be granted when at least one of the first and second forecasted atmospheric parameter values are greater than or equal to a fourth threshold value. If the value of step 154 equals “yes”, the method advances to step 156. Otherwise, the method is exited.

At step 156, the computer 24 queries the atmospheric forecasting system 20 to obtain the first and second forecasted atmospheric parameter values.

Next at step 158, the computer 24 makes a determination as to whether at least one of the first and second forecasted atmospheric parameter values are greater than or equal to the fourth threshold value. If the value of step 158 equals “yes”, the method advances to step 160. Otherwise, the method advances to step 162.

At step 160, the computer 24 indicates that the first atmospheric condition has not been forecasted to occur at the first predetermined time proximate the entertainment facility. After step 160, the method is exited.

At step 162, the computer 24 indicates the first atmospheric condition has been forecasted to occur at the first predetermined time proximate the entertainment facility. After step 162, the method is exited.

The system and method for providing a ticket for entering an entertainment facility in administering provisions of the ticket provides a substantial advantage over other systems and methods. In particular, the system provides a technical effect of refunding at least a portion of the purchase price of a ticket for an event had an entertainment facility when actual or forecasted atmospheric conditions proximate the entertainment facility are not met.

The above-described methods can be embodied in the form of computer-implemented processes and apparatuses for practicing those processes. In an exemplary embodiment, the method is embodied in computer program code executed by the computer or controller. The method may be embodied in the form of computer program code containing instructions embodied in tangible media, such as floppy diskettes, CD-ROMs, hard drives, or any other computer-readable storage medium, wherein, when the computer program code is loaded into and executed by a controller, the controller becomes an apparatus for practicing the invention.

While the invention has been described with reference to an exemplary embodiment, it will be understood by those skilled in the art that various changes may be made and equivalent elements may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. A method for generating and administering a refundable ticket to an entertainment facility, comprising:
generating the ticket that permits a person to enter the entertainment facility, the ticket being offered for a price, the ticket having one or more legal provisions permitting at least a partial refund of the price if at least a first atmospheric condition does not occur at a first predetermined time proximate to the entertainment facility or the first atmospheric condition is not forecasted to occur at the first predetermined time proximate to the entertainment facility;
selling the ticket to the person for the price; and
refunding at least a portion of the price when the first atmospheric condition does not occur at the first predetermined time proximate to the entertainment facility or the first atmospheric condition is not forecasted to occur at the first predetermined time proximate to the entertainment facility.

2. The method of claim 1, wherein the step of refunding at least the portion of the price, comprises:
measuring an atmospheric parameter within a predetermined distance from the entertainment facility at substantially the first predetermined time;
comparing the measured atmospheric parameter to a first threshold value; and
indicating that the first atmospheric condition has not occurred at the first predetermined time proximate the entertainment facility when the measured atmospheric parameter is greater than or equal to the first threshold value.

3. The method of claim 1, wherein the step of refunding at least the portion of the price, comprises:
measuring an atmospheric parameter within a predetermined distance from the entertainment facility at substantially the first predetermined time;
comparing the measured atmospheric parameter to a first threshold value; and
indicating that the first atmospheric condition has not occurred at the first predetermined time proximate the entertainment facility when the measured atmospheric parameter is less than the first threshold value.

4. The method of claim 1, wherein the step of refunding at least the portion of the price, comprises:
obtaining a forecasted value at a second predetermined time indicative of the first atmospheric condition at the first predetermined time within a predetermined distance from the entertainment facility, the second predetermined time preceding the first predetermined time;
comparing the forecasted value to a first threshold value; and
indicating that the first atmospheric condition has not been forecasted to occur at the first predetermined time proximate the entertainment facility when the forecasted value is greater than or equal to the first threshold value.

5. The method of claim 1, wherein the step of refunding at least the portion of the price, comprises:
obtaining a forecasted value at a second predetermined time indicative of the first atmospheric condition at the first predetermined time within a predetermined distance from the entertainment facility, the second predetermined time preceding the first predetermined time;
comparing the forecasted value to a first threshold value; and
indicating that the first atmospheric condition has not been forecasted to occur proximate the entertainment facility at the first predetermined time when the forecasted value is less than the first threshold value.

6. The method of claim 1, wherein the entertainment facility comprises an outdoor entertainment facility or an indoor entertainment facility.

7. The method of claim 1, wherein the first atmospheric condition comprises at least one of a predetermined temperature level, a predetermined amount of precipitation, a predetermined percentage chance of precipitation, a predetermined type of precipitation, a predetermined amount of lightning, a predetermined proximity of lightning, a predetermined density of the lightning, a predetermined percentage of cloud cover, a predetermined barometric pressure level, a predetermined wind direction, a predetermined wind speed, a predetermined wind gust speed, a predetermined visibility distance, a predetermined cloud altitude, and a predetermined dew point temperature.

8. A system for generating and administering a refundable ticket to an entertainment facility, comprising:
an atmospheric monitoring station configured to generate a first atmospheric parameter value indicative of an atmospheric condition proximate the entertainment facility; and
a computer operably communicating with the atmospheric monitoring station, the computer configured to generate the ticket that permits a person to enter the entertainment facility, the ticket being offered for a price, the ticket having one or more legal provisions permitting at least a partial refund of the price if the first atmospheric condition does not occur at a first predetermined time proximate to the entertainment facility, the computer further configured to query the first atmospheric monitoring station to obtain the first atmospheric parameter value, the computer further configured to indicate that a portion of the price is be refunded when the first atmospheric parameter value indicates that the first atmospheric condition did not occur at the first predetermined time proximate to the entertainment facility.

9. The system of claim 8, wherein the first atmospheric parameter value comprises at least one of a temperature level, a precipitation level, a percentage chance of precipitation, a type of precipitation, an amount of lightning, a proximity of lightning, a density of lightning, lightning indicator, a percentage of cloud cover, a barometric pressure level, a wind direction, a wind speed, a wind gust speed, a visibility distance, a cloud altitude, and a dew point temperature.

10. The system of claim 8, wherein the first atmospheric condition comprises at least one of a predetermined temperature level, a predetermined amount of precipitation, a predetermined percentage chance of precipitation, a predetermined type of precipitation, a predetermined amount of lightning, a predetermined proximity of lightning, a predetermined density of the lightning, a predetermined percentage of cloud cover, a predetermined barometric pressure level, a predetermined wind direction, a predetermined wind speed, a predetermined wind gust speed, a predetermined visibility distance, a predetermined cloud altitude, and a predetermined dew point temperature.

11. The system of claim 8, wherein the first atmospheric monitoring station comprises at least one automated atmospheric monitoring station.

12. The system of claim 8, wherein the entertainment facility comprises an outdoor entertainment facility or an indoor entertainment facility.

13. A system for generating and administering a refundable ticket to an entertainment facility, comprising:
an atmospheric forecasting system configured to generate a forecasted atmospheric parameter value at a first predetermined time indicative of a first atmospheric condition at a second predetermined time proximate the entertainment facility, the first predetermined time preceding the second predetermined time; and
a computer operably communicating with the atmospheric forecasting station, the computer configured to generate the ticket that permits a person to enter the entertainment facility, the ticket being offered for a price, the ticket having one or more legal provisions permitting at least a partial refund of the price if the forecasted atmospheric parameter value indicates that the first atmospheric condition will not occur at the second predetermined time proximate to the entertainment facility, the computer further configured to query the first atmospheric monitoring station to obtain the forecasted atmospheric parameter value, the computer further configured to indicate that a portion of the price is be refunded when the forecasted atmospheric parameter value indicates that the first atmospheric condition will not occur at the second predetermined time proximate to the entertainment facility.

14. The system of claim 13, wherein the forecasted atmospheric parameter value comprises at least one of a temperature level, a precipitation level, a percentage chance of precipitation, a type of precipitation, a percentage of cloud cover, a barometric pressure level, a wind direction, a wind speed, a wind gust speed, a visibility distance, a cloud altitude, and a dew point temperature.

15. The system of claim 13, wherein the first atmospheric condition comprises at least one of a predetermined temperature level, a predetermined amount of precipitation, a predetermined percentage chance of precipitation, a predetermined type of precipitation, a predetermined percentage of cloud cover, a predetermined barometric pressure level, a predetermined wind direction, a predetermined wind speed, a predetermined wind gust speed, a predetermined visibility distance, a predetermined cloud altitude, and a predetermined dew point temperature.

16. The system of claim 13, wherein the first atmospheric forecasting station comprises at least one automated atmospheric forecasting station.
